(19) United States
(12) Patent Application Publication
(10) Pub. No.: US 2022/0410441 A1
(43) Pub. Date: Dec. 29, 2022

(54) Production method of an inflatable toy

(71) Applicant: ChuZhou Hengjia Sports Products Limited, ChuZhou City (CN)

(72) Inventor: Shaofeng Shi, Chuzhou City (CN)

(21) Appl. No.: 17/847,590

(22) Filed: Jun. 23, 2022

(30) Foreign Application Priority Data
Jun. 25, 2021 (CN) 202110714548.2

(51) Int. Cl. B29C 41/20; B29C 41/18; A63G 19/00

(52) U.S. Cl. CPC B29C 41/20; B29C 41/18; A63G 19/00; B29K 2027/06

(57) ABSTRACT

This invention discloses a production method of inflatable toy. The first step is to prepare hard PVC powder and soft PVC paste resin. The second step is injection moulding of embedded parts and grasp parts. The third step is preparation of slushing mold or rotational molding mold. The fourth step is shaping of soft PVC paste resin. The fifth step is cooling and demoulding and then air inflation for modeling. The sixth step is installation of grasp parts and inspection and testing of qualified products; in this invention, the secondary forming of hard PVC embedded parts made through injection moulding, are moulded in soft PVC rubber part itself through rotational molding or slush molding in the rotational molding mold or slush molding mold. And then, the grasp parts and embedded parts are firmly connected through buckle or screw. The design has solved the problem of location design of the circular handle, which is unable to be installed in parts other than the joint line through traditional PVC rotational molding mold or slush molding mold. It has perfectly realized the grasp function. In addition, the installation of formed ears or other injection-moulding parts guarantees no deformation of the parts, and this presents a good revivification of product design.

### TECHNICAL FIELD

This invention involves the technical field of inflatable toy, especially the production method of an inflatable toy.

### BACKGROUND TECHNOLOGY

Jumping horse is a kind of body-building toy for kids, of which the features include security, good sanitation and novelty. It's a good toy for kids' sport. Kids are required to adjust the body posture, keep the body in balance in use, so as to enhance the regulating ability of balance, vision, auditory sense and kinesthesis. Hence, the toy has both function of exercise and fitness, and it's also very safe and novel. It's the priority for kids;

At present, the PVC jumping horses and inflatable toys with similar technology in the market are all produced by single rotational molding or slush molding. The traditional PVC rotational molding or slush molding is not able to install annular handle beyond the joint line, which will easily cause slip of the hand and fall from the toy. Besides, in designing the animal-shape product, the ears of the PVC inflatable animal-shape toy produced through forming in one take or other parts requiring high level of revivification will severely transform after inflation, thus causing low qualification rate. Therefore, this invention proposes a production method of inflatable toy to solve the technical problem.

Content of the invention Aiming at the problem above, this invention intends to propose a production method of inflatable toy, where the secondary forming of hard PVC embedded parts made through injection moulding, is completed in soft PVC rubber part through rotational molding or slush molding in the rotational molding mold or slush molding mold. Then, the grasp parts and the embedded parts are firmly connected through button placement or screw structure. The design solves the impossibility of annular handle installed on parts beyond the joint line in the traditional PVC rotational molding or slush molding technology, and realizes perfect grasp function. Besides, the installation of the ears or other injection molding parts at other parts after molding guarantees the non-deformation of the ears, and high level of revivification of the product design.

This invention uses the technical scheme as below to realize the purpose of this invention, and the procedure of producing the inflatable toy is as below:
1) Take raw material of hard and soft PVC to respectively and evenly mix the raw material to make hard PVC powder and soft paste resin of PVC for further production;
2) Prepare the embedded parts and grasp parts. Inject the prepared hard PVC powder in the first step into the corresponding injection mold of the embedded parts and grasp parts by means of injection molding. Then, wait for the molding and demolding;
3) Fix the molded hard PVC embedded parts in the second step at the appropriate position of the corresponding slush-molding mold or rotational molding mold. Then fix the part of inflation inlet on the appropriate position on the internal surface of the mold;
4) Inject the prepared soft PVC paste resin in the first step into the slush-molding mold or rotational molding mold, firmly put the cover on it, and push the slush-molding mold or rotational molding mold into the slush-molding or rotational molding machine for thermoforming mould;
5) Take the slush-molding mold or rotational molding mold out for cooling and demoulding, and take the formed PVC soft rubber parts from the mold and put it in the clamp with the required dimensional design, to inflate it to the designed dimension of the clamp for sizing;
6) Install the grasp parts formed in the second step on the case-hardened rubber parts, and fit the parts with the embedded parts for installing at the appropriate position. Then, check the firmness of between the rubber parts and grasp parts and the level of completeness of the product. Upon the qualification, a toy with grasp parts is produced.

The further improvement lies in the point that position fixing of the hard PVC embedded parts in the third step is conducted by the registration mast in the slush-molding mold or rotational molding mold.

The further improvement lies in the point that the slush-molding mold or rotational molding mold is preheated before injecting the soft PVC paste resin in the fourth step, and the inflated toy is totally put in the water to check gas tightness when checking the level of completeness in the sixth step.

The feature of the toy produced according to the production method of inflatable toy lies in the design that it includes PVC soft rubber part, inflation inlet, embedded parts and grasp parts, and inflation inlet is allocated at the bottom of the PVC soft rubber part, embedded parts are allocated at the upper PVC soft rubber part. And grasp parts are allocated in the embedded parts, and the grasp parts are in the shape of semicircle.

The further improvement lies in the point that installation slot is allocated in the embedded parts, installation columns are allocated at the bottom of the grasp parts, and the grasp parts are installed and connected with the embedded parts through installation columns and installation slot.

The further improvement lies in the point that fitting screw holes are allocated within the embedded parts, mounting screws are allocated at both the ends of the grasp parts, and the grasp parts are installed and connected with the embedded parts through mounting screws and fitting screw holes.

The further improvement lies in the point that plug is allocated at the top of the embedded parts, slot is allocated at the bottom of the rasp parts, and the plug fits with the slot, and they are locked and connected with stop pin.

The further improvement lies in the point that the grasp parts are closely fitting with the PVC soft rubber parts at the opening of the embedded parts, and the grasp parts act as the ears of the toy or the separate grasping handles.

The beneficial effect of this invention is as below: in this production procedure, the secondary forming of hard PVC embedded parts made through injection moulding, is completed in soft PVC rubber part through rotational molding or slush molding in the rotational molding mold or slush molding mold. Then, the grasp parts and the embedded parts are firmly connected through button placement or screw structure. The design solves the impossibility of annular handle installed on parts beyond the joint line in the traditional PVC rotational molding or slush molding technology, and realizes perfect grasp function. Besides, the installation of the ears or other injection molding parts at other parts after molding guarantees the non-deformation of the ears, and high level of revivification of the product design.

### DESCRIPTION FOR FIGURES

FIG. 1 indicates production process of this invention.

FIG. 2 indicates the overall structure of the inflatable toy.

FIG. 3 indicates cross-section of the installation of and connection between the embedded parts and grasp parts in the Implementation 1 of this invention.

FIG. 4 indicates cross-section of the installation of and connection between the embedded parts and grasp parts in the Implementation 2 of this invention.

FIG. 5 indicates cross-section of the installation of and connection between the embedded parts and grasp parts in the Implementation 3 of this invention.

FIG. 6 indicates cross-section of the installation of and connection between the embedded parts and grasp parts in the Implementation 4 of this invention.

FIG. 7 indicates cross-section of the installation of and connection between the embedded parts and grasp parts in the Implementation 5 of this invention.

In the figures, 1 is PVC rubber part; 2 is inflation inlet; 3 is embedded part; 4 is grasp part; 5 is installation slot; 6 is installation column; 7 is the fitting screw; 8 is mounting screw; 9 is plug; 10 is slot; 11 is stop pin; 12 is inner thread groove; 13 is autorotating bolt; 14 is the fitting catching groove; 15 is autorotating lock.

### MODE OF EXECUTION

The technical scheme of this invention will be clearly and integrally described by combining the figures in the implementation. Obviously, the described implementation is just a part of the implementations in this invention, rather than the whole implementations in this invention. Based on the implementation examples in this invention, all the other implementation examples obtained by the common technicians in this field without conducting any creative labor are all within the protection scope of this invention.

In the description of this invention, what needs illustration is that the direction or position relation referred by terms including “center”, “up (top)”, “down(bottom)”, “left”, “right”, “vertical”, “horizontal”, “inner”, “outside” are the direction or position based on the figures, only for the purpose of describing the invention and simplifying description, rather than directing or implying that the devices or elements must have the specified direction, or constructed or operated with specified directions, so it can be considered as the limitation of this invention. In addition, the term “the first”, “the second”, “the third”, “the fourth” and others are only used for description, rather than directing or implying relative importance.

In the description of this invention, what needs to be illustrated is that the term “install”, “installation”, “connect” and “connection” should be read in broad sense. For example, they can refer to fixed connection, detachable connection, or integrated connection; they can be mechanical connection, or electrical connection; they can be directly connected, connected by intermediation, or connected between the inside of two elements. For the common technicians in this field, the specific meaning of terms above in this invention can be read according to specific conditions.

### Implementation Example 1

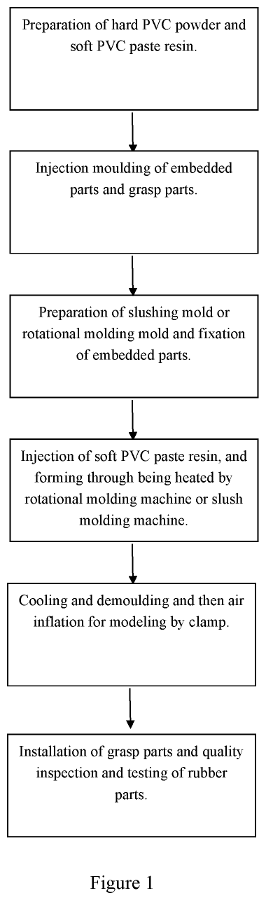

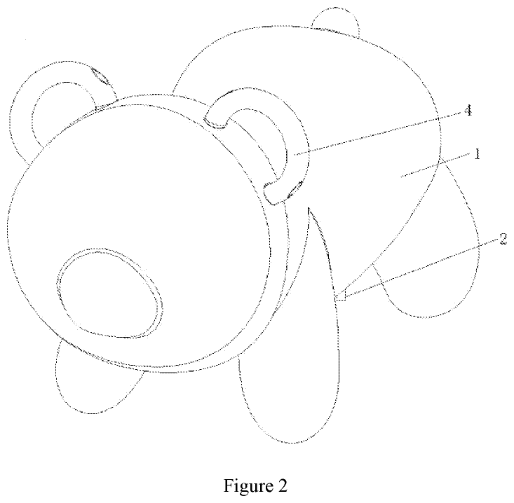

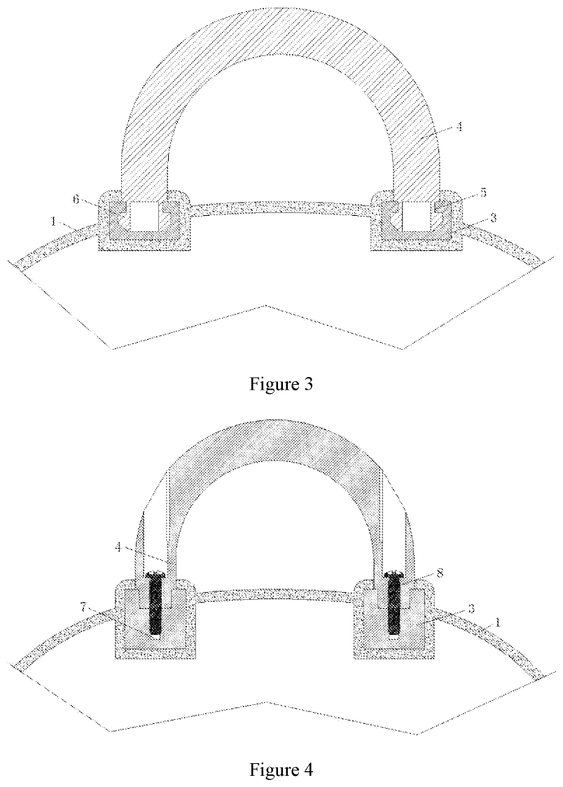

As indicated in FIGS. 1, 2 and 3, a kind of production method of inflatable toy is proposed in this implementation example, and steps are as below:
1) Take raw material of hard and soft PVC to respectively and evenly mix the raw material to make hard PVC powder and soft paste resin of PVC for further production;
2) Prepare the embedded parts and grasp parts. Inject the prepared hard PVC powder in the first step into the corresponding injection mold of the embedded parts and grasp parts by means of injection molding. Then, wait for the molding and demolding;
3) Fix the molded hard PVC embedded parts in the second step at the appropriate position of the corresponding slush-molding mold or rotational molding mold. Then fix the part of inflation inlet on the appropriate position on the internal surface of the mold;
4) Inject the prepared soft PVC paste resin in the first step into the slush-molding mold or rotational molding mold, firmly put the cover on it, and push the slush-molding mold or rotational molding mold into the slush-molding or rotational molding machine for thermoforming mould;
5) Take the slush-molding mold or rotational molding mold out for cooling and demoulding, and take the formed PVC soft rubber parts from the mold and put it in the clamp with the required dimensional design, to inflate it to the designed dimension of the clamp for sizing;
6) Install the grasp parts formed in the second step on the case-hardened rubber parts, and fit the parts with the embedded parts for installing at the appropriate position. Then, check the firmness of between the rubber parts and grasp parts and the level of completeness of the product. Upon the qualification, a toy with grasp parts is produced.

The position fixing of the hard PVC embedded parts in the third step is conducted by the registration mast in the slush-molding mold or rotational molding mold.

The slush-molding mold or rotational molding mold is preheated before injecting the soft PVC paste resin in the fourth step, and the inflated toy is totally put in the water to check gas tightness when checking the level of completeness in the sixth step.

The feature of the toy produced according to the production method of inflatable toy lies in the design that it includes PVC soft rubber part 1, inflation inlet 2, embedded parts 3 and grasp parts 4, and inflation inlet is allocated at the bottom of the PVC soft rubber part, embedded parts 3 are allocated at the upper PVC soft rubber part. And grasp parts are allocated in the embedded parts 3, and the grasp parts 4 are in the shape of semicircle.

The installation slot 5 is allocated in the embedded parts 3, installation columns 6 are allocated at the bottom of the grasp parts 4, and the grasp parts 4 are installed and connected with the embedded parts 3 through installation columns 6 and installation slot 5.

The grasp parts 4 are closely fitting with the PVC soft rubber parts 1 at the opening of the embedded parts 3, and the grasp parts 4 act as the ears of the toy or the separate grasping handles.

### Implementation Example 2

As indicated in FIGS. 1, 2 and 4, a kind of production method of inflatable toy is proposed in this implementation example, and steps are as below:
1) Take raw material of hard and soft PVC to respectively and evenly mix the raw material to make hard PVC powder and soft paste resin of PVC for further production;
2) Prepare the embedded parts and grasp parts. Inject the prepared hard PVC powder in the first step into the corresponding injection mold of the embedded parts and grasp parts by means of injection molding. Then, wait for the molding and demolding;
3) Fix the molded hard PVC embedded parts in the second step at the appropriate position of the corresponding slush-molding mold or rotational molding mold. Then fix the part of inflation inlet on the appropriate position on the internal surface of the mold;
4) Inject the prepared soft PVC paste resin in the first step into the slush-molding mold or rotational molding mold, firmly put the cover on it, and push the slush-molding mold or rotational molding mold into the slush-molding or rotational molding machine for thermoforming mould;
5) Take the slush-molding mold or rotational molding mold out for cooling and demoulding, and take the formed PVC soft rubber parts from the mold and put it in the clamp with the required dimensional design, to inflate it to the designed dimension of the clamp for sizing;
6) Install the grasp parts formed in the second step on the case-hardened rubber parts, and fit the parts with the embedded parts for installing at the appropriate position. Then, check the firmness of between the rubber parts and grasp parts and the level of completeness of the product. Upon the qualification, a toy with grasp parts is produced.

The position fixing of the hard PVC embedded parts in the third step is conducted by the registration mast in the slush-molding mold or rotational molding mold.

The slush-molding mold or rotational molding mold is preheated before injecting the soft PVC paste resin in the fourth step, and the inflated toy is totally put in the water to check gas tightness when checking the level of completeness in the sixth step.

The feature of the toy produced according to the production method of inflatable toy lies in the design that it includes PVC soft rubber part 1, inflation inlet 2, embedded parts 3 and grasp parts 4, and inflation inlet is allocated at the bottom of the PVC soft rubber part, embedded parts 3 are allocated at the upper PVC soft rubber part. And grasp parts are allocated in the embedded parts 3, and the grasp parts 4 are in the shape of semicircle.

The fitting screw holes 7 are allocated within the embedded parts 3, mounting screws 8 are allocated at both the ends of the grasp parts 4, and the grasp parts 4 are installed and connected with the embedded parts 3 through mounting screws 8 and fitting screw holes 7.

The grasp parts 4 are closely fitting with the PVC soft rubber parts 1 at the opening of the embedded parts 3, and the grasp parts 4 act as the ears of the toy or the separate grasping handles.

### Implementation Example 3

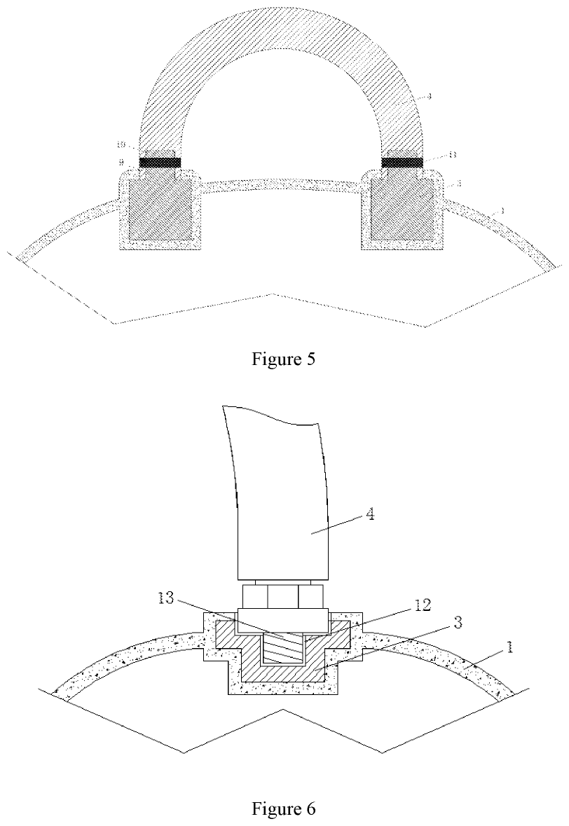

As indicated in FIGS. 1, 2 and 5, a kind of production method of inflatable toy is proposed in this implementation example, and steps are as below:
1) Take raw material of hard and soft PVC to respectively and evenly mix the raw material to make hard PVC powder and soft paste resin of PVC for further production;
2) Prepare the embedded parts and grasp parts. Inject the prepared hard PVC powder in the first step into the corresponding injection mold of the embedded parts and grasp parts by means of injection molding. Then, wait for the molding and demolding;
3) Fix the molded hard PVC embedded parts in the second step at the appropriate position of the corresponding slush-molding mold or rotational molding mold. Then fix the part of inflation inlet on the appropriate position on the internal surface of the mold;
4) Inject the prepared soft PVC paste resin in the first step into the slush-molding mold or rotational molding mold, firmly put the cover on it, and push the slush-molding mold or rotational molding mold into the slush-molding or rotational molding machine for thermoforming mould;
5) Take the slush-molding mold or rotational molding mold out for cooling and demoulding, and take the formed PVC soft rubber parts from the mold and put it in the clamp with the required dimensional design, to inflate it to the designed dimension of the clamp for sizing;
6) Install the grasp parts formed in the second step on the case-hardened rubber parts, and fit the parts with the embedded parts for installing at the appropriate position. Then, check the firmness of between the rubber parts and grasp parts and the level of completeness of the product. Upon the qualification, a toy with grasp parts is produced.

The position fixing of the hard PVC embedded parts in the third step is conducted by the registration mast in the slush-molding mold or rotational molding mold.

The slush-molding mold or rotational molding mold is preheated before injecting the soft PVC paste resin in the fourth step, and the inflated toy is totally put in the water to check gas tightness when checking the level of completeness in the sixth step.

The feature of the toy produced according to the production method of inflatable toy lies in the design that it includes PVC soft rubber part 1, inflation inlet 2, embedded parts 3 and grasp parts 4, and inflation inlet is allocated at the bottom of the PVC soft rubber part, embedded parts 3 are allocated at the upper PVC soft rubber part. And grasp parts are allocated in the embedded parts 3, and the grasp parts 4 are in the shape of semicircle.

Plug 9 is allocated at the top of the embedded parts 3, slot 10 is allocated at the bottom of the rasp parts 4, and the plug 9 fits with the slot 10, and they are locked and connected with stop pin 11.

The grasp parts 4 are closely fitting with the PVC soft rubber parts 1 at the opening of the embedded parts 3, and the grasp parts 4 act as the ears of the toy or the separate grasping handles.

### Implementation Example 4

As indicated in FIG. 6, the implementation example introduces a kind of inflatable toy produced by a kind of product method, and the feature lies in that inner thread groove 12 is allocated on the embedded part 3, and autorotating column 13 is allocated at the bottom of both sides of grasp part 4. Grasp part 4 is connected with embedded part 3 through fitting between autorotating column 13 and inner thread groove 12.

### Implementation Example 5

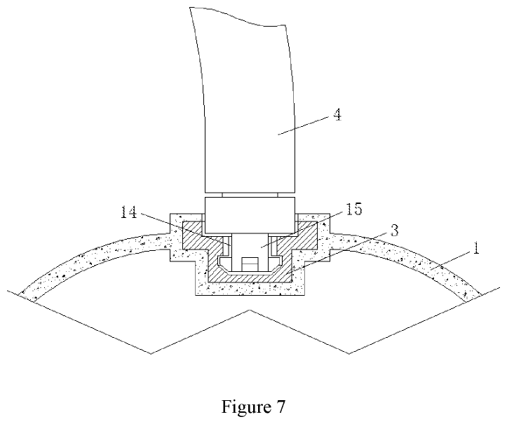

As indicated in FIG. 7, the fitting catching groove 14 is allocated within the embedded part 3, and autorotating lock 15 is allocated at the bottom of both sides of grasp part 4. The grasp part 4 is clamped and connected with the embedded part 3 through connecting the fitting autorotating lock 15 and the fitting catching groove 14 and being rotated for 90°.

In this production procedure, the secondary forming of hard PVC embedded parts made through injection moulding, is completed in soft PVC rubber part through rotational molding or slush molding in the rotational molding mold or slush molding mold. Then, the grasp parts and the embedded parts are firmly connected through button placement or screw structure. The design solves the impossibility of annular handle installed on parts beyond the joint line in the traditional PVC rotational molding or slush molding technology, and realizes perfect grasp function. Besides, the installation of the ears or other injection molding parts at other parts after molding guarantees the non-deformation of the ears, and high level of revivification of the product design.

The contents above indicate and describe the basic principle, main features and advantages of this invention. Technicians in this field should be noted that this invention is not limited by the implementation example above. The description of the implementation example and specification is only used for explaining the principles of this invention. On the precondition of not divorcing from the spirit and scope of this invention, various changes and improvements can be made in this invention, all of which will be included in the required protection range of this invention.

The required protection range of this invention is decided by the attached claims and the corresponding equivalent.

What is claimed is:

1. A production method of an inflatable toy, comprising steps of:
1) taking raw material of hard and soft PVC to respectively and evenly mix the raw material to make hard PVC powder and soft paste resin of PVC for further production;
2) preparing the embedded parts and grasp parts, injecting the prepared hard PVC powder in the first step into the corresponding injection mold of the embedded parts and grasp parts by means of injection molding, and waiting for the molding and demolding;
3) fixing the molded hard PVC embedded parts in step 2) at the appropriate position of the corresponding slush-molding mold or rotational molding mold, a fixing the part of inflation inlet on the appropriate position on the internal surface of the mold;
4) injecting the prepared soft PVC paste resin in step 1) into the slush-molding mold or rotational molding mold, firmly putting the cover, and pushing the slush-molding mold or rotational molding mold into the slush-molding or rotational molding machine for thermoforming mould;
5) taking the slush-molding mold or rotational molding mold out for cooling and demoulding, and taking the formed PVC soft rubber parts from the mold and put in the clamp with the required dimensional design, to inflate to the designed dimension of the clamp for sizing;
6) installing the grasp parts formed in the step 2) on the case-hardened rubber parts, and fitting the parts with the embedded parts for installing at the appropriate position, and checking the firmness of between the rubber parts and grasp parts and the level of completeness of the product; and
7) upon the qualification, a toy with grasp parts is produced.

2. The production method of the inflatable toy as claimed in claim 1, wherein position fixing of the hard PVC embedded parts in step 3) is conducted by the registration mast in the slush-molding mold or rotational molding mold.

3. The production method of the inflatable toy as claimed in claim 1, wherein the slush-molding mold or rotational molding mold is preheated before injecting the soft PVC paste resin in step 4), and the inflated toy is totally put in the water to check gas tightness when checking the level of completeness in step 6).

4. The inflatable toy made by the production method as claimed in claim 1, comprising:
a PVC soft rubber part (1), an inflation inlet (2), embedded parts (3) and grasp parts (4), and an inflation inlet is allocated at the bottom of the PVC soft rubber part, and the embedded parts (3) are allocated at the upper PVC soft rubber part; the grasp parts are allocated in the embedded parts (3), and the grasp parts (4) are in the shape of semicircle.

5. The inflatable toy as claimed in claim 4, wherein installation slot (5) is allocated in the embedded parts (3), installation columns (6) are allocated at the bottom of the grasp parts (4), and the grasp parts (4) are installed and connected with the embedded parts (3) through installation columns (6) and installation slot (5).

6. The inflatable toy as claimed in claim 4, wherein fitting screw holes (7) are allocated within the embedded parts (3), mounting screws (8) are allocated at both the ends of the grasp parts (4), and the grasp parts (4) are installed and connected with the embedded parts (3) through mounting screws (8) and fitting screw holes (7).

7. The inflatable toy as claimed in claim 4, wherein a plug (9) is allocated at the top of the embedded parts (3), a slot (10) is allocated at the bottom of the grasp parts (4), and the plug (9) fits with the slot (10), and they are locked and connected with a stop pin (11).

8. The inflatable toy as claimed in claim 4, wherein the grasp parts (4) are closely fitting with the PVC soft rubber parts (1) at the opening of the embedded parts (3), and the grasp parts (4) act as the ears of the toy or the separate grasping handles.
